(19) United States
(12) Patent Application Publication
(10) Pub. No.: US 2006/0056015 A1
(43) Pub. Date: Mar. 16, 2006

(54) Microscope control system and control method

(75) Inventor: Yasuo Nishiyama, Tokyo (JP)

Correspondence Address: Thomas Spinelli;Scully, Scott, Murphy & Presser, 400 Garden City Plaza, Garden City, NY, 11530, US

(73) Assignee: Olympus Corporation, Tokyo (JP)

(21) Appl. No.: 11/222,271

(22) Filed: Sep. 8, 2005

(30) Foreign Application Priority Data
Sep. 10, 2004 (JP) 2004-264269

(51) Int. Cl. G02B 21/00

(52) U.S. Cl. 359/368

(57) ABSTRACT

A power generation unit generates power to be transmitted to a moving part, and a control unit outputs a drive instruction to the power generation unit so as to drive the moving part. An operational information storage unit stores operational information which indicates a content of how a control unit has driven the power generation unit to operate the moving part. Saving the operational information enables the manufacturer to confirm an actual usage condition, thereby making it possible for the manufacturer to respond easily in various ways.

### CROSS REFERENCE TO RELATED APPLICATIONS

This application claims benefit of Japanese Applications No. 2004-264269, filed Sep. 10, 2004, the contents of which are incorporated by this reference.

### BACKGROUND OF THE INVENTION

1. Field of the Invention

The present invention relates to a microscope control system for controlling a microscope apparatus having a moving part.

2. Description of the Related Art

A microscope is a indispensable apparatus for observation a specimen. Usually, a microscope allowing such an observation comprises at least one moving part which constitutes specifically an optical apparatus such as a revolver, aperture stop, or shutter; a switching mechanism for switching a filter, light path, et cetera; a moving mechanism for moving a mirror, lens or focusing mechanism, et cetera. A majority of microscopes operates at least one moving part by a actuator, thereby improving the operability or versatility. An operation of moving part is usually carried out by a microscope control system.

The manufacturer (of a microscope, unless otherwise noted herein) usually commercialize an apparatus with an assumption for a durable period (i.e., life), during which time the apparatus is desired to experience no occurrence of failure. This is because a failure occurrence lowers an availability factor, which incurs a loss on the part of the user. Consequently, a repeated occurrence of failures gives an unfavorable impression about the manufacturer. That actually is more often than not the case.

There is a possibility of failure occurrence in a moving part, or furthermore in the physical power source such as actuator for supplying the moving part with power. There is a case where some of components constituting a moving part require a consideration for an abrasion (i.e., wear) or reduced strength in association with usage for instance. Accordingly, a development of apparatus including a microscope usually confirms a durability of apparatus under development through a durability testing, et cetera.

Such testing enables a confirmation of possibly occurring failures and the respective mechanisms, and of durability of components, and thereby a development of microscope with a high durability.

But, it is not always possible to confirm all actual failures and the respective causes. There is a possibility of problem occurrence such as unpredictable failure possibly caused by an actual usage environment or mode, or a maintenance procedure. An appropriate response to such a problem occurrence is required on the part of the manufacturer, which leads to an importance of acquiring information for the purpose of responding to such a problem occurrence.

As one of the conventional techniques, a Japanese patent laid-open application publication No. 09-223034 has noted a technique for counting an odometer in a vehicle and measuring the running time of an engine. Another Japanese patent laid-open application publication No. 10-38605 has noted a technique for counting the amount of usage of a pump and measuring a connection time to a commercial power source thereof. Yet another Japanese patent laid-open application publication No. 2002-90641 has noted a microscope apparatus which measures an on-time of light source and illumination time of light on the specimen.

Actually, the microscope noted in the Japanese patent laid-open application publication No. 2002-90641 measures the illumination time for the purpose of suppressing a damage on the specimen by the light exposure by the light source, and the on-time for the purpose of confirming the life of the light source. It is important to enable an acquisition of information about a moving part in order to respond to a problem occurrence associated with equipping the moving part in a microscope, but none of the above described techniques put forth by these patent applications is comprised to detect a condition of such moving part as being equipped therewith, hence unable to respond to a problem occurrence properly.

### SUMMARY OF THE INVENTION

A microscope control system as a first aspect of the present invention, assuming to control a microscope having a moving part, comprises a power generation unit for generating power to be transmitted to the moving part; a control unit for outputting a drive instruction to the power generation unit so as to operate the moving part; and an operational information storage unit for storing operational information which indicates a content of how the moving part operates.

A microscope control system as a second aspect of the present invention further comprises an operation detection unit for detecting an operation of the moving part, in addition to the comprisal for the above described first aspect, wherein the operational information storage unit stores, as operational information, the number of operation of the moving part detected by the operation detection unit.

A microscope control system as a third aspect of the present invention, assuming to control a microscope having an illuminating light source, comprises an illumination control unit for turning the light source to emit light; and an operational information storage unit for storing information, as operational information, which indicates a content of how the illumination control unit has turned the light source to emit light.

A microscope control method as a first aspect of the present invention, assuming to control a microscope having a moving part, comprises the steps of making a power generation unit operate the moving part by outputting a drive instruction to the power generation unit which generates power to be transmitted to the moving part; and storing operational information which indicates a content of how the moving part operates by the drive instruction.

A microscope control method as a second aspect of the present invention, assuming to control a microscope having an illuminating light source, comprises the steps of turning on the light source to emit light; and storing information which indicates a content of how the light source has been turned on to emit light, as operational information.

The present invention saves operational information chronicling how the moving part, which operates on a transmitted power, has operated. The operational information indicates an actual usage condition by the user, that is, how the microscope has been used. Therefore, the manufacturer is enabled to confirm the actual usage condition as a result of saving such operational information. Accordingly, if an actual failure occurs, the failure cause can be identified more easily based on the condition and actual usage at the time. As for a development of microscope, not only the difference between the assumed usage and actual usage conditions, but also the actually occurred failures and their frequencies, et cetera, can be reflected to the development activities, and therefore a microscope with a better durability and higher reliability (e.g., availability) can be developed easily. Putting all these together, it is possible to respond to a problem occurrence during the usage by the users more easily and accurately after all.

Meanwhile, if a notification is made when the operational information meets a prescribed condition, a notification of information to be advised to the user and/or a service representative over at the manufacturer will reach in a timely manner. This makes it possible to advise a checking or maintenance (e.g., replacement of spare parts) adequately, thereby continuously assisting a comfortable use of the microscope.

The above described benefit can be likewise gained in the case of letting information, indicating a content of how the illumination control unit has turned on the light source to illuminate, stored as operational information.

### BRIEF DESCRIPTION OF THE DRAWINGS

The present invention will be more apparent from the following detailed description when the accompanying drawings are referenced.

FIG. 1 shows a composition of microscope control system according to an embodiment of the present invention;

FIG. 2 is a flow chart of memory initialization processing at turning power on;

FIG. 3 is a flow chart of revolver drive processing;

FIG. 4 is a flow chart of aperture stop drive processing; and

FIG. 5 is a flow chart of power supply shutoff interruption processing.

### DESCRIPTION OF THE PREFERRED EMBODIMENTS

The following is a detailed description of the preferred embodiment of the present invention while referring to the accompanying drawings.

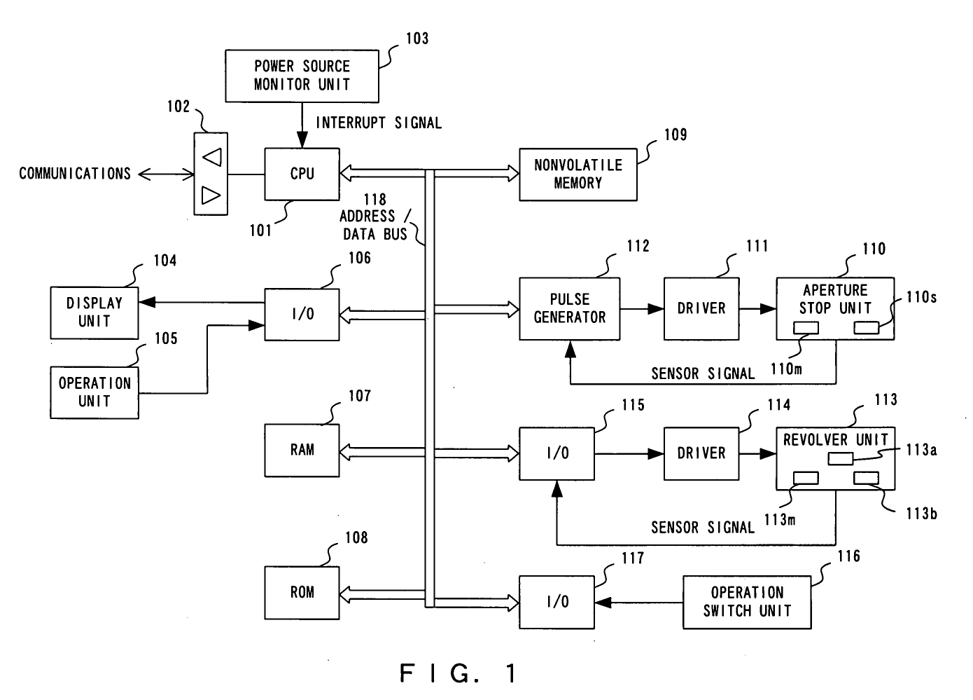

FIG. 1 shows a composition of microscope control system (apparatus) according to the present embodiment.

The microscope control system is disposed to control such as a microscope for carrying out an observation of specimen by letting a light source (not shown herein) emit light, comprising a CPU (central processing unit) 101 for controlling the overall system; a communication control unit 102 for communicating with an external apparatus; a power source monitor unit 103 for detecting a turning off of a power source (not shown); a display unit 104 for use in displaying various information; an operation unit 105 for assuming an operation by a service personnel in carrying out a check and maintenance operations; an I/O (input & output) unit 106 for displaying information in the display unit 104 and inputting operational information indicating an operation content carried out by the service personnel using the operation unit 105; a RAM 107 used by the CPU 101 for a work area; a ROM 108 storing a program executed by the CPU 101 and a series of control-use data; a nonvolatile memory 109; an aperture stop unit 110 for adjusting an intensity of light and a cone angle of light entering the objective lens; a driver 111 for driving a motor (e.g., stepping motor) 110m adopted as actuator disposed for the aperture stop 110; a pulse generator 112 for generating a pulse signal used by the driver 111 driving the motor 110m and for controlling the driver 111; a revolver unit 113 allowing mounting of a plurality of objective lenses; a driver 114 for driving a motor (e.g., DC motor) 113m adopted as actuator disposed for the revolver unit 113; an I/O unit 115 for controlling the driver 114; an operation switch unit 116 for including a plurality of user switches; an I/O unit 117 for inputting operational information from the operation switch unit 116; and an address & data bus 118 for interconnecting the each component units 101, 106 through 109, 112, 115 and 117, all as shown by FIG. 1.

The above noted nonvolatile memory 109 comprehends a semiconductor memory maintained as nonvolatile by a battery for example, a flash memory or any other storage media, which may be equipped either fixedly or detachably attached.

The aperture stop 110 comprises one or more position, sensors 110s as a sensor for detecting a position of a member being moved by the motor 110m. The positional sensor 110s is used for detecting the original point at a power on.

The revolver unit 113 comprises, as sensors, a position sensor 113a for identifying the position of a hole for an objective lens and a click sensor 113b for detecting the objective lens being right on the optical axis (of the microscope herein, unless otherwise noted).

The operation switch unit 116 comprises, as switches disposed for the user operation, switches for instructing to rotate the revolver unit 113 and switches for instructing an opening or closing of aperture by the aperture stop unit 110, with the former switches existing respectively for the right and left rotations of the revolver unit 113 since it allows a bidirectional rotation. And the latter switches also exist respectively for an opening or closing of the aperture which is configured to allow an opening and closing separately. Therefore, the switches for instructing a rotation of the revolver unit 113 rightward and leftward will be hereinafter called a “right switch” and “left switch”, respectively, for convenience. Likewise, the switches for instructing to open and close the aperture will be called “open switch” and “close switch”, respectively.

The user operating these switches is detected by the operation switch unit 116 for example and the detection result is sent over to the CPU 101 as operational information by way of the I/O unit 117 and address & data bus (hereinafter called “bus”) 118. The CPU 101 operates the aperture stop unit 110 or revolver unit 113 by way of the pulse generator 112 or I/O unit 115 in accordance with the operational information sent over in such a way.

For instance, opening or closing the aperture is performed for as long as the user is operating the respective switches. Accordingly, if there is a notification of operating the open switch for example by the operational information, the CPU 101 lets the opening operation of the aperture continued by way of the pulse generator 112 until a release of operating the switch is notified by the operational information. The operation lets the pulse generator 112 carry out by specifying the direction of rotating the motor 110m. This lets the driver 111 drive the motor 110m by a pulse signal from the pulse generator in the direction instructed by the CPU 101 for as long as the CPU 101 instructs an operation of the pulse generator 112. This operation is the same when an operation of the close switch is notified by operational information. A sensor signal outputted from the position sensor 110s comprised by the aperture stop unit 110 is sent to the CPU by way of the pulse generator 112.

Meanwhile, the revolver unit 113 is configured to rotate indexing one objective lens to the next in the direction as selected by either the left or right switch. The motor 113m is configured to rotate in the right direction when switching on one of both sides thereof to be applied by a voltage, while in the left direction when switching on the other. Accordingly, a control of the motor 113m is through the on or off control of the either side thereof.

Being notified of operating the left or right switch by the operational information, the CPU 101 instructs the I/O unit 115 to rotate the revolver unit 113 by specifying a rotating direction. The I/O unit 115 lets the driver 114 rotate the motor 113m in the specified rotating direction as per the instruction.

The CPU 101 monitors a sensor signal from the I/O unit 115 so as to rotate the motor 113m until the next objective lens moves right in line with the optical axis. This makes an objective lens located on the optical axis switch with the one located on the next thereto in the direction specified by an operating switch every time the user operates either the left or right switches.

The aperture stop unit 110 and revolver unit 113 operate on electric power under the control of CPU 101 as described above. The present embodiment is comprised to save operational information indicating the content of driving them. The nonvolatile memory 109 is used for saving the operational information which includes the number of times either the open or close switches are operated for the aperture stop unit 110 and the number of times either the left or right switches are operated for the revolver unit 113. These numbers of times will be called “aperture stop drive count” and “revolver drive count”, respectively, hereinafter for convenience.

The CPU 101, upon a power on, reads operational information out of the nonvolatile memory 109 to write in the RAM 107, and renew the operational information which has been written as the aforementioned information every time either the aperture stop unit 110 or revolver unit 113 is operated. The renewed operational information as such is saved in the nonvolatile memory 109 by overwriting it at a power off. Such configuration makes it possible to read the most recent operational information out of the nonvolatile memory 109. The operational information can be confirmed by either displaying in the display unit 104, or sent out to an external apparatus by way of the communication control unit 102, in compliance with an operation on the operation unit 105.

The above described saving of operational information enables the manufacturer to grasp firmly the actual usage condition of how many times the user operating the moving parts such as the aperture stop unit 110 and revolver unit 113. This makes it possible to identify a cause of failure more easily from the state or an actual usage condition if and when the failure actually occurs. As for a development of microscope, not only the difference between the assumed usage and actual usage conditions, but also the actually occurred failures and their frequencies, et cetera, can be reflected to the development activities, and therefore a microscope with a better durability and higher reliability (e.g., availability) can be developed easily. Putting all these together, it is possible to respond to a problem occurrence during the usage by the users more easily and accurately after all.

It is also necessary to take actions so as to prevent a failure from occurring in a moving part with a higher usage frequency actually than the assumed usage, while it is possible to adopt a component, et cetera, with a reasonably lower reliability for the other moving parts. This will enable a development of microscope with a better durability and higher reliability while suppressing a production cost reasonably.

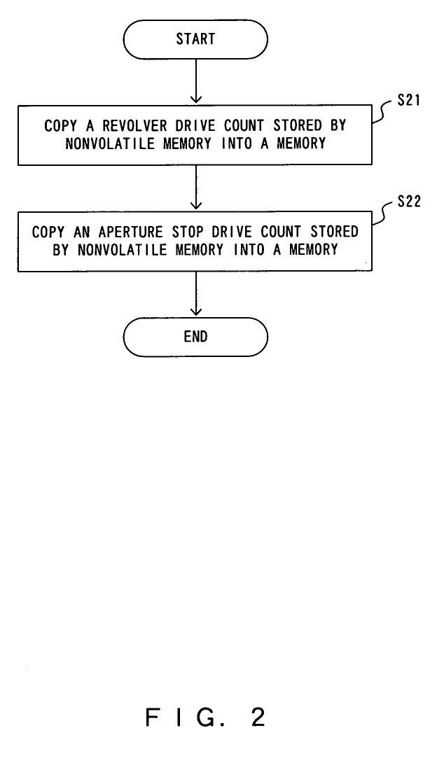

The CPU 101 renews the above described operational information. The following descriptions deal with operations of the CPU 101 relating to renewing the operational information in further details while referring to a series of flow charts shown by FIGS. 2 through 5. Note that the CPU 101 executing a program stored by the ROM 108 accomplishes a series of processing shown by the flow charts in FIGS. 2 through 5.

FIG. 2 is a flow chart of memory initialization processing at turning power on. The first description is about the initialization processing in detail while referring to FIG. 2. The initialization processing is to read operational information (i.e., a revolver drive and aperture stop drive counts herein) stored by the nonvolatile memory 109 at a power on to copy in the RAM 107.

The first step is to access the nonvolatile memory 109, read a revolver drive count out thereof and copy by writing the readout revolver drive count in the RAM 107 (S21). The next step is to access the nonvolatile memory 109, read an aperture drive count out thereof and copy by writing the readout aperture stop drive count in the RAM 107 (S22). After copying all the operational information stored by then on volatile memory 109 thusly, the series of processing ends.

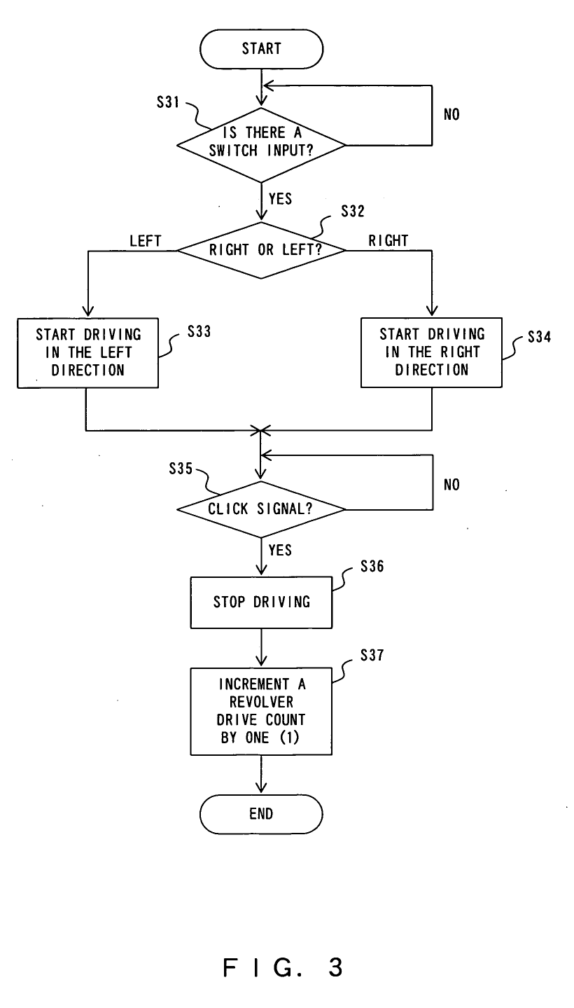

FIG. 3 is a flow chart of revolver drive processing. The revolver drive processing illustrates an overall flow of processing for the CPU 101 carrying out in order to drive the revolver unit 113 in response to the user operating either the left or right switches. The next processing is about the revolver drive processing in detail while referring to FIG. 3.

The first step is to wait for an operation of either the left or right switches (S31). If the operator operates on either, the I/O unit 117 sends out operational information indicating such an operation to the CPU 101, making the judgment of the step S31 a “yes” to transit to step S32.

Then judge a category of the switch the user has operated (S32). If the operational information received from the I/O unit 117 indicates the user operating on the left switch, the judgment is the user operating the left switch so as to transit to the step S33 and instruct the I/O unit 115 to rotate the revolver unit 113 in the left direction (S33). On the other hand, if the operational information indicates the user operating on the right switch, the judgment is the user operating the right switch so as to transit to the step S34 and instruct the I/O unit 115 to rotate the revolver unit 113 in the right direction (S34). After instructing either of the above described instructions, transit to the step S35.

Positioning an objective lens mounted onto the revolver unit 113 right in line with the optical axis makes a sensor signal (i.e., click signal) outputted from a click sensor 113b indicate as such. Because of this, the next step is to wait for the I/O unit 115 sending out a click signal indicating an objective lens positioning itself right in line with the optical axis (S35). Having received the click signal from the I/O unit 115, instruct the I/O unit 115 to stop driving the revolver unit 113 (S36), followed by incrementing a revolver drive count (S37) to end the series of processing.

The present embodiment is configured to increment a value of revolver drive count stored by the RAM 107 every time the user operating on either the left or right switch, regardless of its direction as described above. Note that the revolver drive count may be renewed per kind of the switch (i.e., rotating direction of the revolver unit 113) by equipping the respective counters.

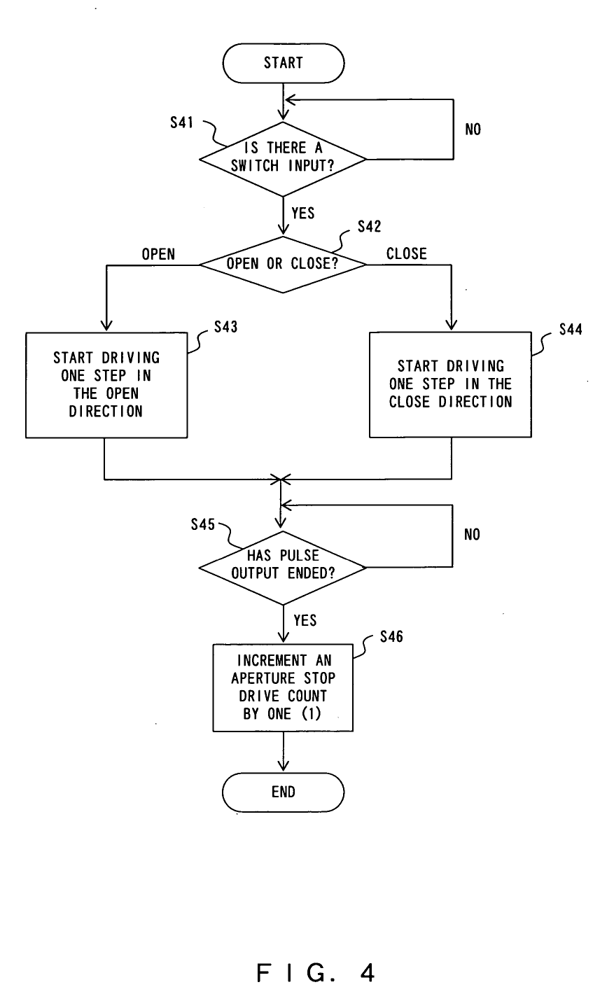

FIG. 4 is a flow chart of aperture stop drive processing. The aperture stop drive processing illustrates an overall flow of processing for the CPU 101 carrying out in order to drive the aperture stop unit 110 in response to the user operating either of the open or close switches. The next processing is about the aperture stop drive processing in detail.

The first step is to wait for an operation of either the open or close switches (S41). If the operator operates on either, the I/O unit 117 sends out operational information indicating such an operation to the CPU 101, making the judgment of the step S41 a “yes” to transit to step S42.

Then judge the kind of switch the user has operated (S42). If operational information received from the I/O unit 117 indicates the user operating on the open switch, the judgment is the user operating the open switch so as to transit to the step S43 and instruct the pulse generator 112 to open the aperture in the aperture stop unit 110 (S43). On the other hand, if the operational information indicates the user operating on the close switch, the judgment is the user operating the close switch so as to transit to the step S44 and instruct the pulse generator 112 to close the aperture in the aperture stop unit 110 (S44). After instructing either of the above described instructions, transit to the step S45. After instructing either of the above described instructions, transit to the step S45.

When the pulse generator 112 finishes to output a drive pulse for the specified one step (S45) and increments a value of aperture stop drive count stored by the RAM 107 by one (S46), followed by ending the series of processing.

As such, the present embodiment is configured to increment a value of aperture stop drive count stored by the RAM 107 every time the user operates on either the open or close switch regardless of its direction as in the case of the revolver drive count. Note that the aperture stop drive count may be renewed depending on the kind of switch by equipping the respective counters.

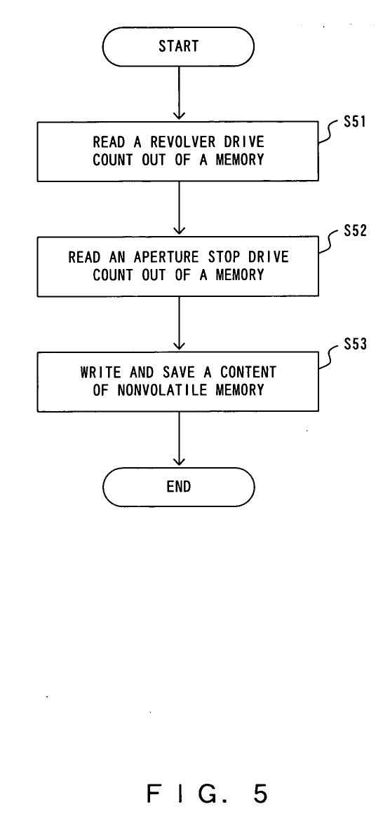

FIG. 5 is a flow chart of power supply shutoff interruption processing which is started by an interrupt signal outputted from the power source monitor unit 103 for notifying a power shutoff. The last description herein is about the interruption processing in detail while referring to FIG. 5.

The first is to read a revolver drive count out of the RAM 107 in order to write in the nonvolatile memory 109 (S51), followed by reading an aperture stop drive counter out of the RAM 107 likewise (S52), again followed by writing and storing the revolver drive count and aperture stop drive count which has been read out of the RAM 107 in the nonvolatile memory 109 (S53) to end the series of processing.

As described above, the present embodiment is configured to write operational information (i.e., revolver drive count and aperture stop drive count herein) in the nonvolatile memory 109 only at a power shutoff. This is because a nonvolatile memory has a limit in the amount of writing. Writing operational information in such characterized nonvolatile memory 109 only at a power shutoff enables a saving of the operational information accurately while suppressing the amount of writing to a minimum.

The revolver unit 113 or the aperture stop unit 110 may have a replacement part in addition to a need to check for maintenance. Intervals for such a check and replacement of part are usually predetermined. In consideration of this, the present embodiment is configured to pre-store a revolver drive count and aperture stop drive count applicable to such intervals in the nonvolatile memory 109, notify the user when an actual count value reaches at either of the aforementioned counts so as to advise a maintenance check or a replacement of relevant part. Such a notification enables the user to secure a use of the microscope always in an appropriate condition.

While a judgment of whether or not the condition meeting to require a notification and the resultant notification is not limited, it may be done in the above described step S37 or S46. The notification may be carried out by using the display unit 104, or by sending out a message to an external apparatus by way of a communication control unit 102 if such external apparatus is connected by way thereof.

If the revolver drive count and aperture stop drive count are set up or saved as condition for a notification, the actual revolver drive count and aperture stop drive count need to be reset when a check for maintenance or a replacement of applicable part is actually carried out. The present embodiment is configured to allow the reset through an operation on the operation unit 105, or an external apparatus connected with the communication control unit 102. When the reset is instructed, the CPU 101 writes and saves zeros (0) as the values of the revolver drive count and aperture stop drive count in the nonvolatile memory 109, respectively.

Note that the present embodiment is configured to save the respective numbers of operating the revolver unit 113 and aperture stop unit 110 as operational information, but the kind of moving part for saving the operational information is not limited as such. Moving parts as subjects of saving the respective pieces of operational information may actually include an optical apparatus such as field stop and shutter; a switching mechanism for switching filters, light paths, et cetera; a moving mechanism (e.g., focusing, and switching light paths) for moving a mirror, lens or focusing mechanism, and et cetera. As for the operational information to be saved, the number of operations (e.g., the numbers of on's and off's) illumination light source such as the number of on's and off's of mercury lamp may be included, in addition to the above described numbers of operations of switching mechanism and moving mechanism. The content of operational information to be saved may be suitably changed according to the moving part as the subject.

While the present embodiment is configured to count the numbers of operations of the revolver unit 113 and aperture stop unit 110 is as per operation on the respective switches, the counting may be carried out by a result of detecting an operation by an operation detection unit such as the click sensor 113b and position sensor 110s which detect an actual operation of the moving part. Such configuration may further make it possible to count a presence or absence of operation of actuator such as a switch for instructing an operation. In the case of counting the presence or absence of operation, it is possible to count the number of manual operations of the moving part, thereby enabling a failure analysis more suitably and easily.

While the condition for notifying the user assumes a checking operation or a replacement of spare part, other consideration may be given. Specifically, a maintenance operation may be assumed. A plurality of conditions may be set so as to change the contents of notification in stages under the assumption that the user may not listen to the notification. If there are plural numbers of replacement parts, one condition or more may be set for each replacement part.

A program for accomplishing the above described operations of microscope control system may be distributed by recording in a storage medium such as a CD-ROM, DVD, and flash-memory. Alternatively, either the entirety or a part thereof may be distributed by way of transmission medium such as a communication network or a public network. Such a comprisal enables the manufacturer to apply the present invention to an existing microscope control system by loading the program thereon. Accordingly, the storage medium may be accessible by an apparatus for distributing the program.

Meanwhile, the present invention is in no way limited by the usage method put forth by the above described present embodiment, and for instance, a practice of predicting a moving part, et cetera, in need of maintenance or check operations in advance by way of a communication line just before a service personnel from the manufacturer calls on the user site for maintenance or check operations acquires the benefit of reducing the time of service following the visit at the user site.

What is claimed is:

1. A microscope control system for controlling a microscope having a moving part, comprising:
a power generation unit for generating power to be transmitted to the moving part;
a control unit for outputting a drive instruction to the power generation unit so as to operate the moving part; and
an operational information storage unit for storing operational information which indicates a content of how the moving part operates.

2. The microscope control system according to claim 1, wherein
said operational information storage unit, having a nonvolatile storage device, saves said operational information by letting the storage device store it.

3. The microscope control system according to claim 2, wherein
said operational information storage unit reads and renews the operational information stored by said storage device and saves the renewed operational information by letting the storage device store information at a power shutoff.

4. The microscope control system according to claim 3, comprising
a power source monitor unit for monitoring a power condition and detecting a power shutoff.

5. The microscope control system according to claim 2, wherein
said nonvolatile storage system is a semiconductor memory or flash memory.

6. The microscope control system according to claim 2, wherein
said nonvolatile storage system can be detachably attached.

7. The microscope control system according to claim 1, wherein
said operational information storage unit stores, as said operational information, number of operation of said moving part as a result of said control unit driving said power generation unit.

8. The microscope control system according to claim 1, wherein
said operational information storage unit stores, as said operational information, number of times said control unit outputting a drive instruction for driving said power generation unit.

9. The microscope control system according to claim 1, further comprising
an operation detection unit for detecting an operation of said moving part, wherein
said operational information storage unit stores, as operational information, number of operation of the moving part detected by the operation detection unit.

10. The microscope control system according to claim 1, further comprising
a notification unit for notifying of a fact that the operational information stored by said operational information storage unit satisfies a pre-stored condition when it occurs.

11. The microscope control system according to claim 10, wherein,
if said operational information storage unit stores, as said operational information, number of operations of said moving part, said condition is number of times to be notified of, and
said notification unit comprises a communication control unit for sending out a message to an external apparatus when the number of operations stored as said operational information reaches at the number of times prepared as the condition.

12. The microscope control system according to claim 1, wherein
said moving part is at least either one of switching mechanism for switching a revolver, aperture, shutter, filter or light path, and a moving mechanism for moving a mirror, lens or focusing mechanism.

13. A microscope control system for controlling a microscope having an illuminating light source, comprising:
an illumination control unit for turning the light source to emit light; and
an operational information storage unit for storing information, as operational information, which indicates a content of how the illumination control unit has turned the light source to emit light.

14. The microscope control system according to claim 13, wherein
said operational information storage unit, having a nonvolatile storage device, saves said operational information by letting the storage device store it.

15. The microscope control system according to claim 14, wherein
said operational information storage unit reads and renews the operational information stored by said storage device and saves the renewed operational information by letting the storage device store information at a power shutoff.

16. The microscope control system according to claim 15, comprising
a power source monitor unit for monitoring a power condition and detecting a power shutoff.

17. The microscope control system according to claim 13, wherein
said operational information storage unit stores, as said operational information, number of times said light source is turned on according to a turn-on instruction outputted by said illumination control unit.

18. The microscope control system according to claim 13, further comprising
a notification unit for notifying of a fact that operational information stored by said operational information storage unit satisfies a pre-stored condition when it occurs.

19. A microscope control method for controlling a microscope having a moving part, comprising the steps of
making a power generation unit operate the moving part by outputting a drive instruction to the power generation unit which generates power to be transmitted to the moving part; and
storing operational information which indicates a content of how the moving part operates by the drive instruction.

20. A microscope control method for controlling a microscope having an illuminating light source, comprising the steps of
turning the light source to emit light; and
storing information which indicates a content of how the light source has been turned on to emit light, as operational information.
